(19) United States
(12) Patent Application Publication
(10) Pub. No.: US 2016/0055551 A1
(43) Pub. Date: Feb. 25, 2016

(54) SYSTEM AND METHOD FOR PROVIDING WEB-BASED USER FEEDBACK

(71) Applicant: Usman Hafeez, Chicago, IL (US)

(72) Inventor: Usman Hafeez, Chicago, IL (US)

(21) Appl. No.: 14/925,198

(22) Filed: Oct. 28, 2015

Related U.S. Application Data
(63) Continuation-in-part of application No. 13/913,600, filed on Jun. 10, 2013.

(51) Int. Cl. G06Q 30/02; G06Q 50/00; H04L 29/08

(52) U.S. Cl. CPC G06Q 30/0282; H04L 67/306; H04L 67/1044; G06Q 30/0205; G06Q 50/01

(57) ABSTRACT

The present invention generally relates to computer and web-based shopping services and real world comparison feedback services. Specifically, this invention relates to systems and methods for providing web-based social shopping services and real world comparison feedback services whereby users can create groups based on various criteria in order to get real-time or near real-time feedback and opinions regarding online and real world purchases, potential purchases and comparisons.

### CROSS-REFERENCE TO RELATED APPLICATIONS

The present application is a continuation in part of and claims priority to non-provisional U.S. patent application Ser. No. 13/913,600 entitled “System and Method for Providing Web-Based User Feedback” filed Jun. 10, 2013, the contents of which are incorporated by reference herein in their entirety.

### FIELD OF THE INVENTION

The present invention generally relates to computer and web-based shopping services and real world comparison feedback services. Specifically, this invention relates to systems and methods for providing web-based social shopping services and real world comparison feedback services whereby users can create groups based on various criteria in order to get real-time or near real-time feedback and opinions regarding online and real world purchases, potential purchases and comparisons.

### BACKGROUND

As our world becomes more and more connected via web-based systems, many everyday tasks are becoming streamlined and integrated with sophisticated technology. From dating to shopping, many of our experiences are being optimized through mobile and web-based technologies.

One of the most ubiquitous experiences provided over web-based system relate to commerce, and in particular, online shopping. Frequently, consumers rely on the ratings and reviews from other individuals they have never met or associated with in order to gain initial comfort with a product or service they have never seen or otherwise used, prior to purchasing the product or service.

Consumers desire feedback, particularly when it comes to buying a product/service, either to assist with picking between products & services, or in rating a singular product or service. One drawback with the presently implemented system of feedback/reviews offered by most e-commerce providers is that feedback provided on these systems can be highly suspect. In many cases, anyone can leave the feedback on an item/service and the feedback/comments left can be anonymous. In some cases, the e-commerce provider may pay individuals to rate and review their goods/service even when the individual has never used the product/service or had any experience with the e-commerce provider.

Further, even where reviewers are actual users of a product or service, there is no way for a potential consumer to know what level of experience or expertise the reviewer has. For instance, a review about an expensive purchase (e.g., professional photography equipment) from a person with no relative experience in the field of the purchase generally carries as much weight as a review from an industry expert with respect to most e-commerce providers.

While individuals would prefer to have reviews/recommendations from friends/colleagues/family or other individuals they know personally/professionally, currently there is no good way for this to be effected. A user is currently limited to emailing or otherwise contacting individuals through a user's online social networks for such recommendations. However, there are many cases where a user would not want to request such recommendations from all individuals in their social network(s). For instance, there may be only a handful of connections an individual would want recommendations from when it comes to specific products (e.g., fashion) or services (e.g., doctor referral). Simply asking your entire network for recommendations can be troublesome and end up complicating the end result. There is also no good way to reach out to people you do not know who are within the network of those within your network, nor is there a good way to determine the subject matter expertise of those people not within your immediate network.

Therefore, there is need in the art for a computer and web-based systems and methods for providing web-based user feedback services whereby users can create groups based on various criteria in order to get real-time or near real-time feedback and opinions regarding online and real world purchases, potential purchases and comparisons. These and other features and advantages of the present invention will be explained and will become obvious to one skilled in the art through the summary of the invention that follows.

### SUMMARY OF THE INVENTION

Accordingly, it is an aspect of the present invention to provide a system and method for providing social shopping services and real world comparison feedback services whereby users can create groups based on various criteria in order to get real-time or near real-time feedback and opinions regarding online and real world purchases, potential purchases and comparisons.

According to an embodiment of the present invention, a system for providing social shopping services and real world comparison feedback services, the system including: a social networking module, comprising computer-executable code stored in non-volatile memory, a commerce review module comprising computer-executable code stored in non-volatile memory, a processor, and a communications means, wherein the social networking module, the commerce review module, the processor, and the communications means are operably connected and are configured to: receive information regarding a plurality of social contacts from a user; generate one or more social groupings based on input received from the user wherein each of the one or more social groupings comprises one or more social contacts selected from the plurality of social contacts; identify one or more goods, services or items based on input received from the user, wherein the one or more goods, services or items are identifiable via an electronic medium; receive a selection of one or more of the one or more social groupings from the user, wherein the selection forms a review group; receive review parameters from the user; communicate a request for recommendations to each social contact in the review group; receive one or more recommendations from at least one social contact in the review group; and transmit the one or more recommendations to the user.

According to an embodiment of the present invention, the social networking module, the commerce module, the processor, and the communications means are further configured to receive one or more recommendations from an individual who is not one of the plurality of social contacts, where the individual is a social contact of one or more of the plurality of social contacts.

According to an embodiment of the present invention, the review parameters include a degree of separation wherein the degree of separation defines the extent to which individuals who is not one of the plurality of social contacts can provide recommendations.

According to an embodiment of the present invention, a location module, comprising computer-executable code stored in non-volatile memory, said location module operably connected to and configured to work in conjunction with said social networking module, said commerce module, said processor, and said communications means.

According to an embodiment of the present invention, the location module is configured to provide location information to assist in the identification of the one or more goods, services or items and the generation and selection of one or more of the one or more social groupings. In certain embodiments, this is assisted through the discovery of advisors within a given geographic location

According to an embodiment of the present invention, the electronic medium is selected from the group comprising an image of said one or more goods, services or items, a uniform resource locator, and an electronic document associated with said one or more goods, services or items.

According to an embodiment of the present invention, the electronic medium is provided via a mobile computing device associated with the user.

According to an embodiment of the present invention, the integrated hardware of the mobile computing device is utilized to provide the electronic medium.

According to an embodiment of the present invention, the integrated hardware is selected from the group comprising, a microphone, a camera, a near field communications means, a wireless communications means, a Bluetooth communications means, a global positioning means or other location identification means, and a radio frequency identification means.

According to an embodiment of the present invention, the social networking module, the commerce module, the processor, and the communications means are further configured to generate, based on user input, one or more product groupings wherein each of the one or more product grouping is comprised of one or more of the one or more goods, services or items.

According to an embodiment of the present invention, a web-based method for providing social shopping services and real world comparison feedback services includes the steps of: receiving information, at a social networking module, regarding a plurality of social contacts from a user; generating, via the social networking module, one or more social groupings based on input received from the user wherein each of the one or more social groupings comprises one or more social contacts selected from the plurality of social contacts; identifying, via a commerce module, one or more goods, services or items based on input received from the user, wherein the one or more goods, services or items are identifiable via an electronic medium; receiving a selection of one or more of the one or more social groupings from the user, wherein the selection forms a review group; receiving review parameters from the user; communicating a request for recommendations to each social contact in the review group; receiving one or more recommendations from at least one social contact in the review group; and transmitting the one or more recommendations to the user.

According to an embodiment of the present invention, the method further includes the step of receiving one or more recommendations from an individual who is not one of the plurality of social contacts, where the individual is a social contact of one or more of the plurality of social contacts.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a network schematic of a system, in accordance with an embodiment of the present invention;

FIG. 4 illustrates a schematic of a location based social shopping & comparison module, in accordance with an embodiment of the present invention;

FIG. 5 illustrates a schematic of a location based social shopping & comparison module, in accordance with an embodiment of the present invention; and

FIG. 6 is a process flow of an exemplary method in accordance with embodiments of the present invention; and

FIG. 7 is a process flow of an exemplary method in accordance with embodiments of the present invention;

FIG. 8A is an exemplary embodiment of a graphical user interface used in conjunction with a preferred embodiment of the present invention;

FIG. 8B is an exemplary embodiment of a graphical user interface used in conjunction with a preferred embodiment of the present invention;

FIG. 8C is an exemplary embodiment of a graphical user interface used in conjunction with a preferred embodiment of the present invention;

FIG. 8D is an exemplary embodiment of a graphical user interface used in conjunction with a preferred embodiment of the present invention;

FIG. 8E is an exemplary embodiment of a graphical user interface used in conjunction with a preferred embodiment of the present invention; and

FIG. 8F is an exemplary embodiment of a graphical user interface used in conjunction with a preferred embodiment of the present invention.

### DETAILED SPECIFICATION

The present invention generally relates to computer and web-based social shopping & comparison services. Specifically, this invention relates to systems and methods for obtaining real time advice from a user's advisors, utilizing location based services and filtering technologies as well as web-based shopping services and other criteria.

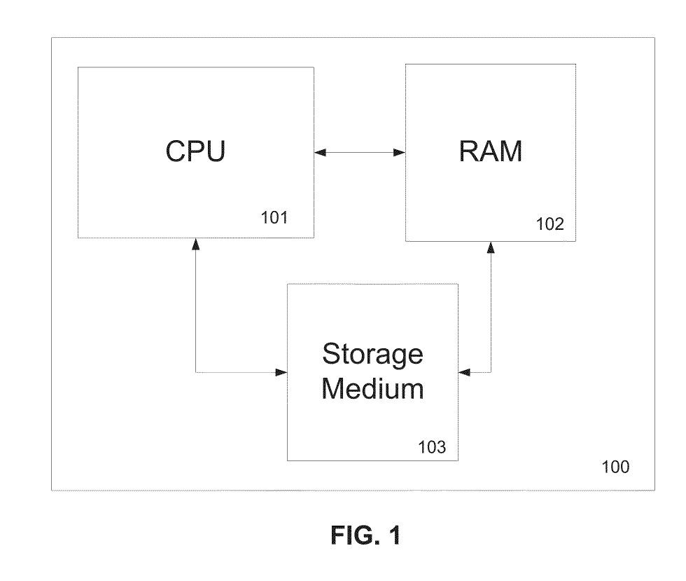

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

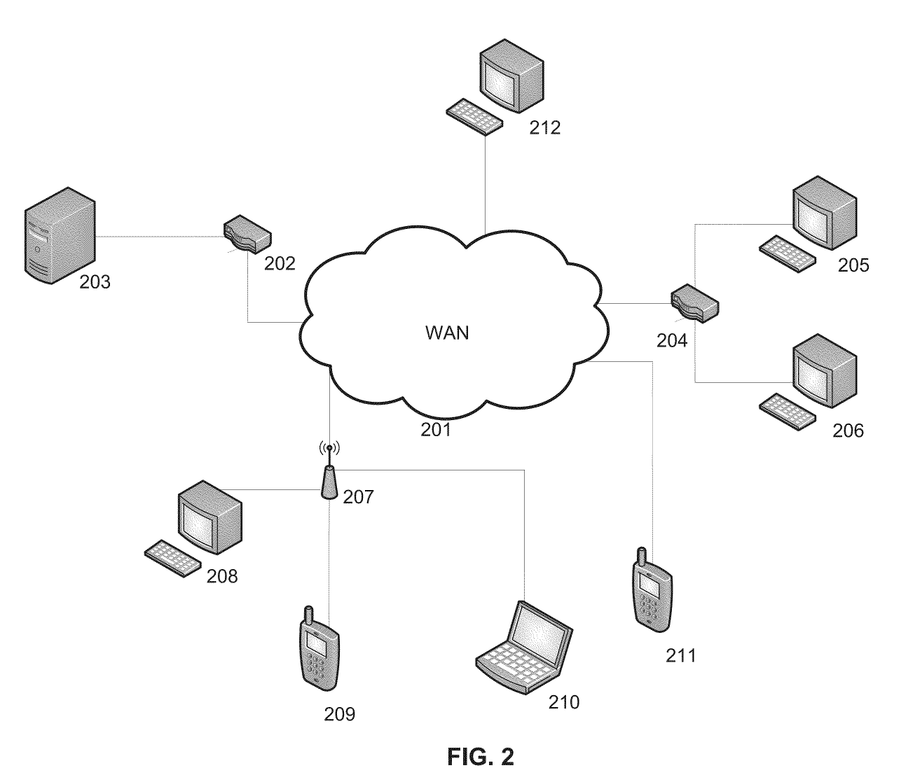

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

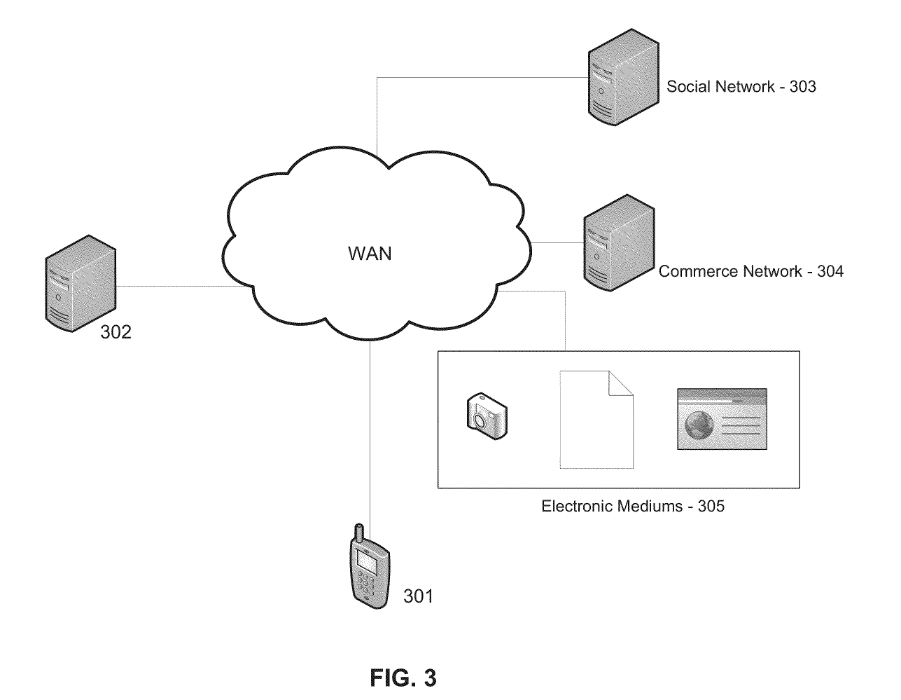

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of a social network 303, a e-commerce API/website or other third party commerce system 304, one or more direct links or other directly provided data in the form of an electronic medium 305 (e.g., product photo, product brochure, service description, uniform resource locator (URL)) or any combination thereof. One of ordinary skill in the art would appreciate how accessing one or more third-party systems could augment the ability of the system described herein, and embodiments of the present invention are contemplated for use with any third-party system.

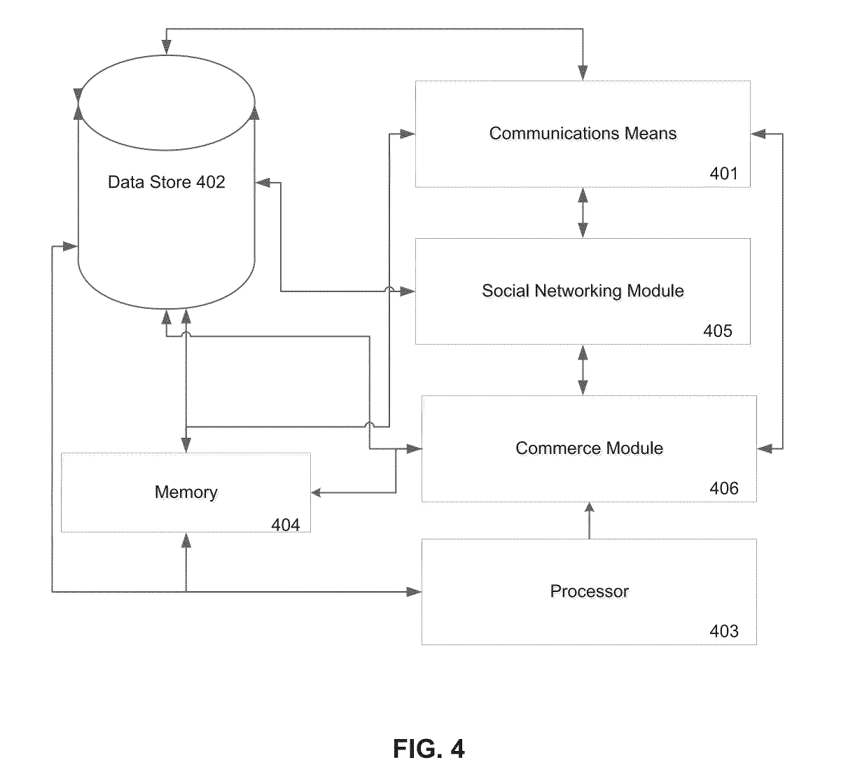

Turning to FIG. 4, according to an embodiment of the present invention, a system for providing a location based social shopping & comparison is comprised of one or more communications means 401, one or more data stores 402, a processor 403, memory 404, a social networking module 405 and a commerce module 406. In alternate embodiments, the system may have additional or fewer components. One of ordinary skill in the art would appreciate that the system may be operable with a number of optional components, and embodiments of the present invention are contemplated for use with any such optional component.

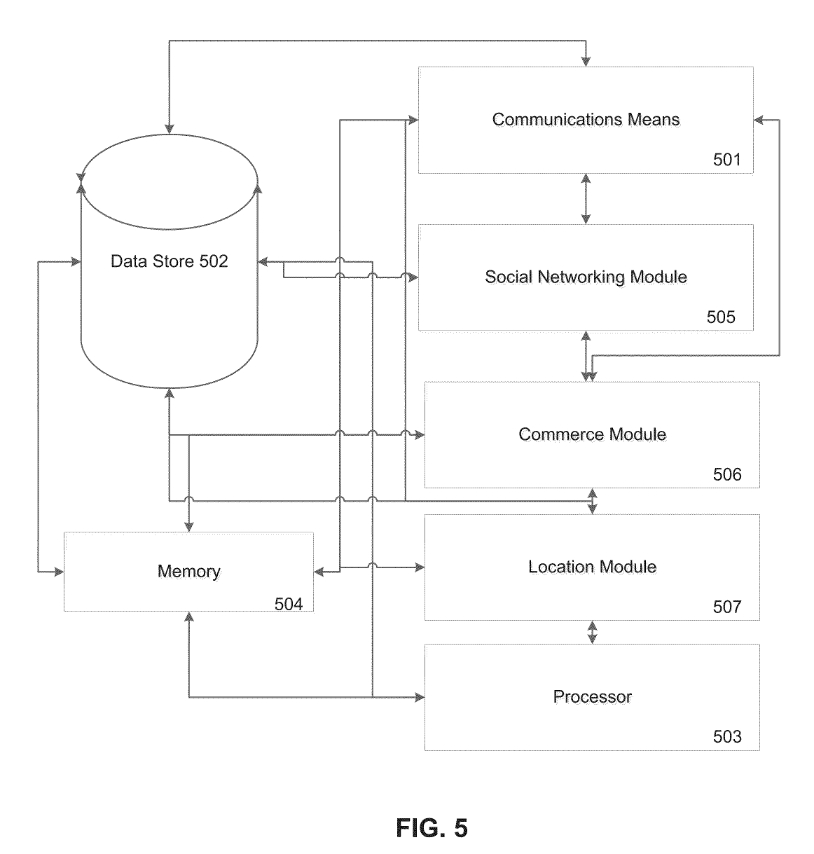

FIG. 5, shows an alternate embodiment of a system for providing location based social shopping & comparison, comprised of one or more communications means 501, one or more data stores 502, a processor 503, memory 504, a social networking module 505 a commerce module 506 and further including a location module 507. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the social networking module is configured to provide users the ability to link, group and sort contacts in various manners such that they can be connected to and used by the system in order to assist with the methodologies described herein. The social networking module may further be configured to analyze process and communicate information from and between one or more third-party systems to assist or otherwise improve the recommendation process. Third-party systems may include, but are not limited to, social networks, professional networks and any other third-party network. In a preferred embodiment, the accessibility to these third-party systems may be by way of API or other programmatic communications means.

According to an embodiment of the present invention, one of the main features of the social networking module is to allow users to aggregate their connections, whether those connections associated with the system (e.g., members) or those connections associated with other systems (e.g., third-party social networks, connections via electronic contact books, connections via software systems such as e-mail programs). In preferred embodiments of the present invention, the social networking module further allows the user to create and organize these connections into various groups, based on any criteria the user determines important. For instance, a user may create a group of connections for friends and a separate group of connections for family. More granularly, a user may narrow down these groups based on very specific criteria, for instance, a user may create a group of connections that have experience or other qualifications in fashion with the goal of using that group to gain insight specifically on questions related to fashion. One of ordinary skill in the art would appreciate that there are numerous criteria upon which users could organize and arrange their connections, and embodiments of the present invention are contemplated for use with any such criteria.

According to an embodiment of the present invention, The social networking module allows users to store, sort, update, label, organize and otherwise change and rearrange the groups they utilize and the members of those groups via one or more graphical user interfaces accessible via a computing device, whether mobile (e.g., smartphone, tablet PC) or stationary (e.g., desktop PC). In certain embodiments, the social networking, communication, location and commerce modules may be provided as a graphical user interfaces via integration into one or more browsers or other software applications installed or otherwise utilized on a computing device of the user (e.g., plugin for a web browser).

The social networking module may further be utilized to allow users to extend the functionality of the system to the connections of the user's connections. In other words, a user may request that the social networking module include in a group, the contacts of their connections when requesting usage of the system as a recommendation system. The system may allow the user to set the limit to which the system will include such contacts. For instance, the user may only wish to include the contacts of the user's contacts (2^{nd} level connections), but can extend this out as far as the user would like (i.e., n level depth of contacts for n level connections).

According to an embodiment of the present invention, the commerce module is configured to allow a user to identify product, services and/or items the user is interested in receiving feedback on. The commerce module is configured to allow a user to identify a product, service or item via one or more electronic mediums, such electronic medium to be stored in the system or otherwise able to be referenced by the system for the identification of the goods, services or items. Electronic mediums include, but are not limited to, uniform resource locators (URLs), images files (e.g., JPGs, GIFs), document files (e.g., DOCs, PDFs), other web data (e.g., HTML data, XML), or any combination thereof. One of ordinary skill in the art would appreciate that there are numerous types of electronic mediums that could be utilized with embodiments of the present invention, and embodiments of the present invention are contemplated for use with any electronic medium.

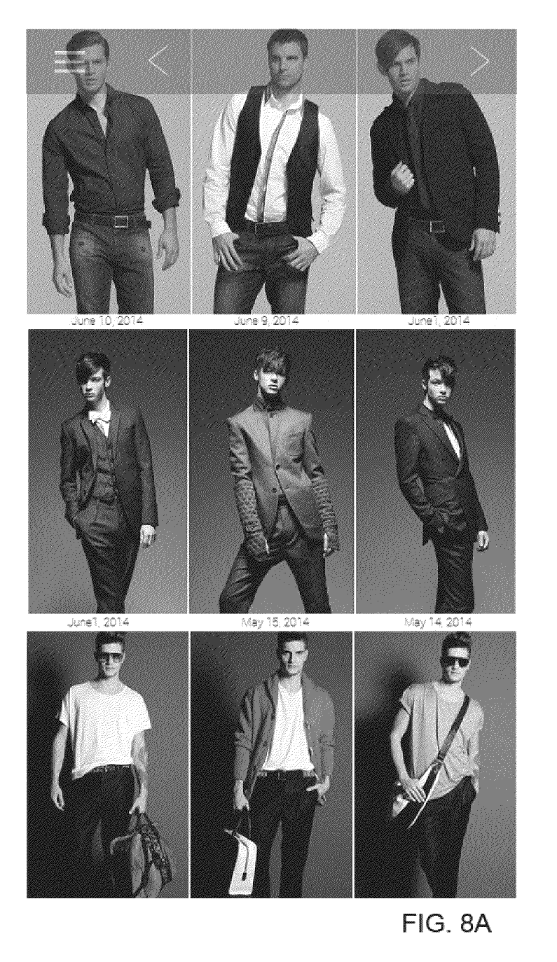

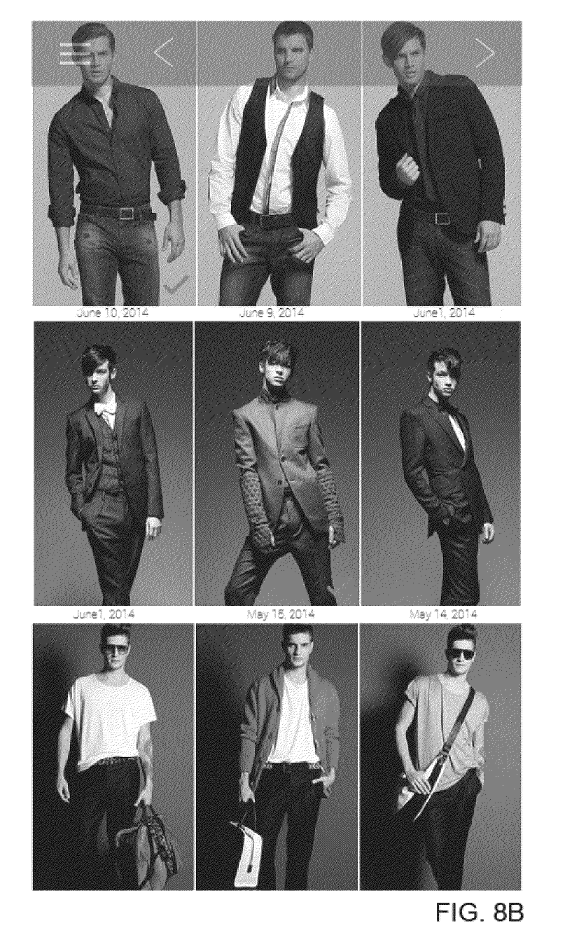

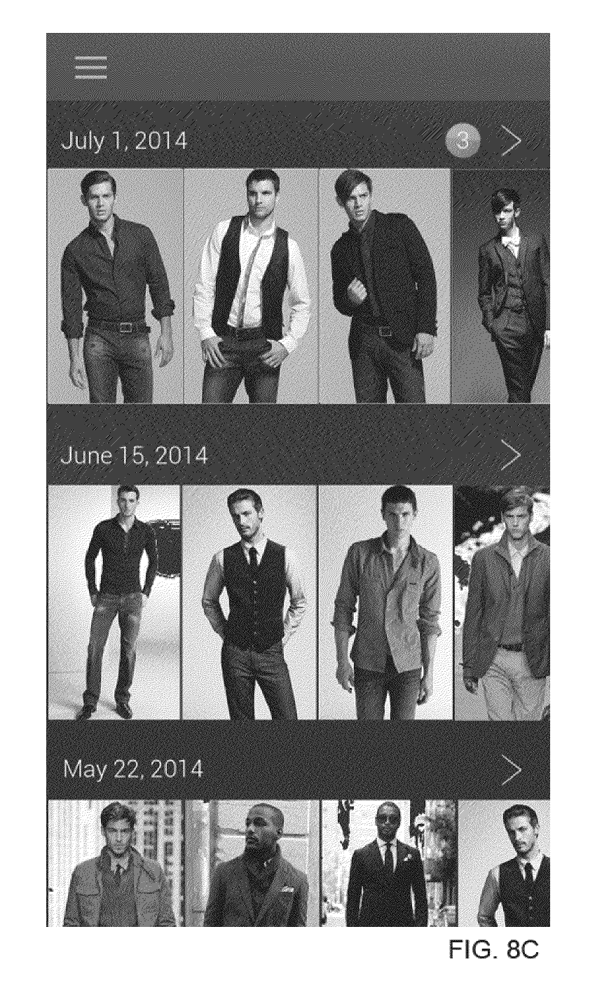

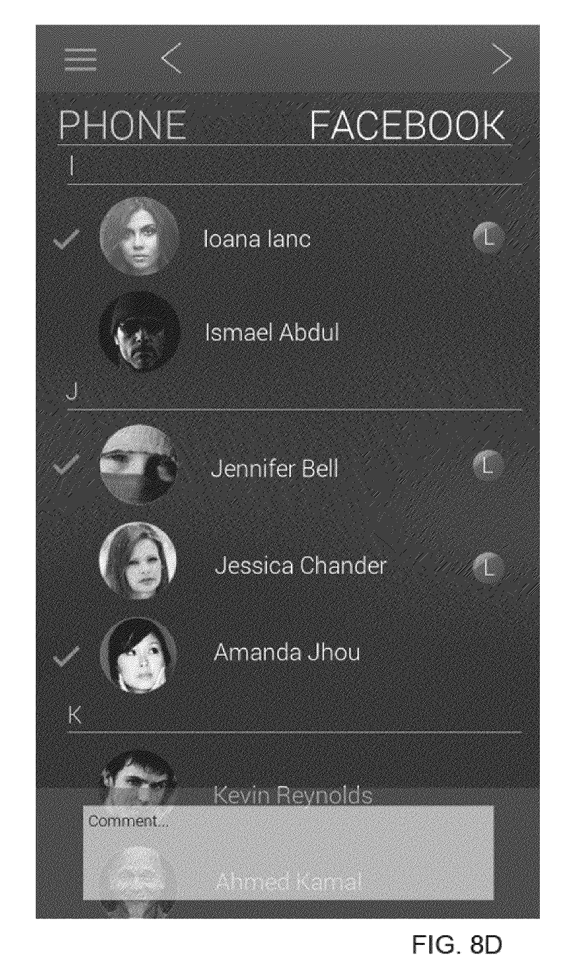

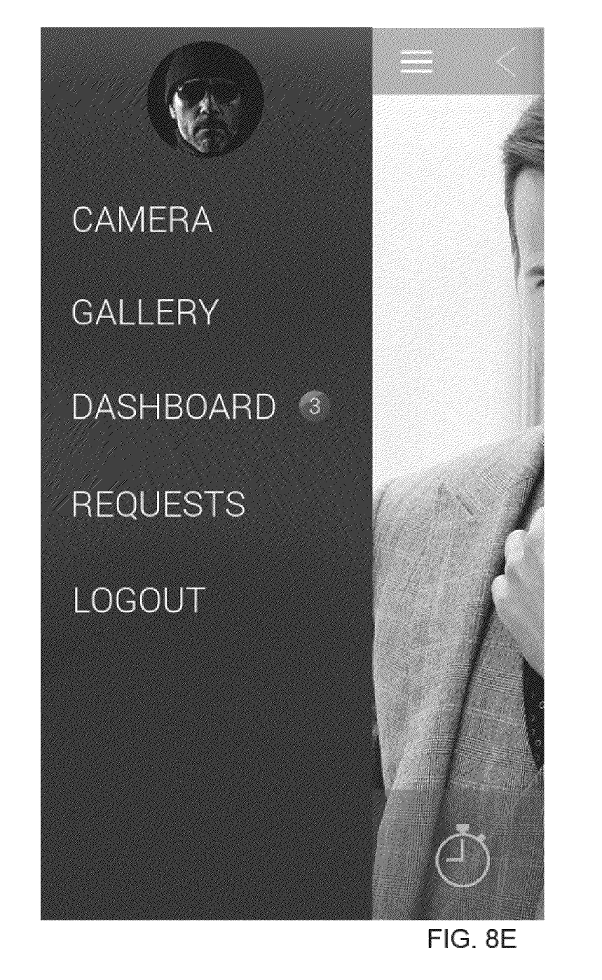

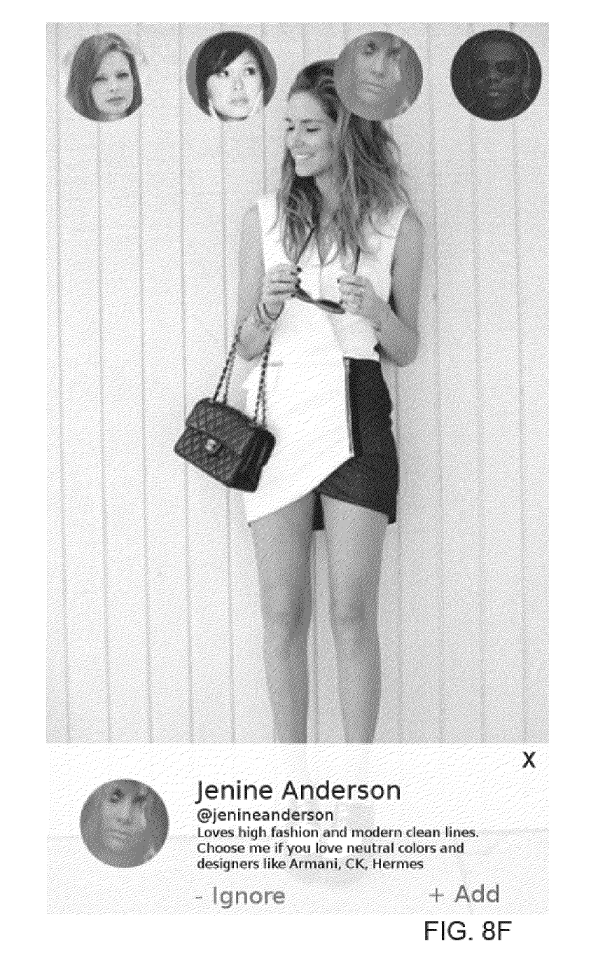

In a preferred embodiment of the present invention, the commerce module may further be configured to provide the user with a gallery of the stored electronic mediums, organized in an efficient and cognizable manner. For instance, the gallery may provide users with a collection of thumbnail or other references to stored electronic mediums in a manner that is organized by some relevant criteria (e.g., date stored, category of product identified in electronic medium, category of electronic medium type, popularity of electronic medium with regards to recommendations received). An exemplary embodiment of the gallery view is shown in FIG. 8A, wherein a thumbnail display of 9 electronic mediums comprising photographs are shown. Further in this exemplary embodiment, the electronic mediums are organized and sorted by date stored in the system. Continuing with this preferred embodiment, FIG. 8B details an exemplary embodiment of a gallery where the user has selected an electronic mediums to take further action on, as identified by checkmarks overlaid upon the selected electronic mediums.

According to an embodiment of the present invention, the location module is configured to provide location based services (LBS) to enhance user experience and functionality. The location module may be configured to utilize location based information provided from the user via one or more location means (e.g., Global position System (GPS), cellular triangulation, IP address location) to provide specific information and services to the user. For instance, location data can be used by the user to form a group of potential contacts to provide feedback on a product or service with geographic relevance, such as the quality of a restaurant or hotel in a specific area. As local contacts may have more valuable input, these LBS enhance the ability of the user to select specific contacts for their groups and for the provision of feedback.

According to an embodiment of the present invention, the commerce module and the social network module, along with the other components of the system, are configured to work in conjunction with one another to allow the system to generate requests for feedback on goods and/or services, where the requests are sent to a limited number of individuals as defined by specifically selected groups previously identified by the user initiating the request. The methods are described in greater detail below.

According to an embodiment of the present invention, the system first allows a user to formulate one or more groups for providing recommendations/feedback. In order to do this, the system may allow the user to identify her connections (e.g., friends, family, colleagues) which are gathered any connection source. Connection sources include, but are not limited to, social networks (Facebook, Google+. LinkedIn), contacts within email accounts (e.g., Gmail, Yahoo Mail, Outlook), contacts from software applications (e.g., accounting software, contact book software). The system may be configured to automatically identify and retrieve information from sources. For instance, the system may use one or more third-party APIs to draw requested contact information from the third-party system.

According to an embodiment of the present invention, connections can not only be organized into different groups, but they can also be connected to the system through various means. For instance, connections may be connected to the system through one or more contact means, such as a phone number, social media profile or account (e.g., FACEBOOK account, LINKEDIN account), messaging application account (e.g., SNAPCHAT, WHATSAPP), or any combination thereof. In this manner, the system can contact every member of a group in a method that is appropriate for their contact means. If a user has a group that has contacts with varying contact means, the system will message each contact with the appropriate contact means for that contact. An exemplary embodiment of this is shown in FIG. 8D, where contacts are shown from various contact means, such as PHONE and FACEBOOK. Further, in FIG. 8D, contacts that are members of the system and can be contacted directly through the system are denoted by indicia next to their name/image (i.e., a circle with a “L” in the middle).

According to an embodiment of the present invention, where the contact means is a phone number, the system may be configured to send a message to the phone number, such as a SMS or MMS message. In preferred embodiments, when communicating with a contact that has a phone number as a contact means, the system may further be configured to identify and send the appropriate type of message based on information known about the device receiving the message. In this manner, the system can determine if a SMS or MMS is more appropriate given on the receiving device. Further, in instances where the contact means is a phone number, the SMS or MMS may be comprised of a URL or other link that directs the receiving device back to a webpage associated with the user requesting recommendations.

According to an embodiment of the present invention, where the contact means is a social media profile or account, or a messaging application account, the system may be configured to connect to the social media system or messaging system and provide a message directly to the contact via that platform. For instance, in most social media systems and messaging applications, an API is provided that allows for submission of messages or other contacts to users of the systems and applications. This can be particularly useful where a user is using a device which does not store contacts, but may have access to one or more social media profiles or accounts or other messaging applications. In such case, the system can utilize the contact methods provided by those social media profiles or messaging applications to send messages. One of ordinary skill in the art would appreciate that there are numerous methods in which the system could communicate with third party social media systems and messaging systems for the transmission of messages to such platforms, and embodiments of the present invention are contemplated for use with any appropriate method for accomplishing such communications.

Further, in certain embodiments, the system may be configured to retrieve contact information for contact means, even where such information is not readily available to a device the user is connecting to the system with. For instance, the system may be configured to use APIs of third parties that store contact information for users remotely (e.g., GOOGLE CONTACTS through the GOOGLE API). In this manner, with the provision of login information, the system can retrieve contact means for contacts, even when they are not locally available on the user's computing device. This allows the system to provide the convenience of reaching the user's contacts without entry of individual contact means when not locally available on the user's computing device.

According to an embodiment of the present invention, the system may provide the user with the ability to organize and arrange the groups as they see fit. The user may organize and arrange the groups on any number of criteria, including, but not limited to, association, affiliation, age, gender, education, profession, hobbies, subject matter expertise, location or any combination thereof. One of ordinary skill in the art would appreciate that there are numerous types of criteria by which the system can allow the user to arrange the groups and individuals belonging to those groups on, and embodiments of the present invention are contemplated for use with any such criteria.

According to an embodiment of the present invention, the system may be configured to allow users to add products/services/items from any source (e.g., website with an image of the product/service) into a central repository (e.g., data store) within the system. In general, this storage is in the format of an electronic medium as previously described herein. In a preferred embodiment, the products/services/items are linked back to an original webpage where information about the product/service can be found.

According to an embodiment of the present invention, the system may be configured to allow for receipt or provision of electronic mediums through any number of means. For instance, users of a desktop may be able to upload images/documents or provide URLs associated with products/services. In other embodiments, such as with users of a mobile device (e.g., smartphone), integrated hardware may be utilized to provide the capture of such electronic mediums. For instance, the integrated hardware of a smartphone, such as a camera, near field communication device, radio-frequency identification (RFID) tag reader, barcode scanner, Bluetooth communications means, wireless communications means (e.g., WIFI) or other integrated hardware, may be utilized to capture the electronic medium and provide the electronic medium to the system.

In preferred embodiments, the electronic mediums are received from a remote computing device and the information is parsed by the system for appropriate storage and categorization in order to assist with future utilization of the electronic mediums. For instance, data from the electronic medium can be sorted out into various categories of information, such as image or other graphical data, URL links, textual information and metadata. By sorting out the data, the system can store the data in the appropriate data stores or databases for retrieval as necessary. In this manner, data can be retrieved as necessary for each use case. For instance, when sending data about an electronic medium to a mobile phone via SMS, the system may only desire to send textual information and URL links as other data may not be displayed via SMS. As such, the system can be configured to use the categorized data appropriately with each contact and contact means in order to efficiently provide recommendation requests to groups selected by the user.

According to an embodiment of the present invention, the system may be further configured to notify the user as recommendations are received by the system. In a preferred embodiment, the system may be configured to provide push notifications to the user for each recommendation received from one or more recommenders. In other embodiments, other form of notifications may be used, including, but not limited to, SMS notifications, email notifications, social media platform notifications, or any combination thereof. One of ordinary skill in the art would appreciate that there are numerous types of notifications that could be used with embodiments of the present invention, and embodiments of the present invention are contemplated for use with any appropriate notification type.

In certain embodiments, the system may be configured to allow a user to make an ad hoc group from their contacts based on a singular or multiple of products/services. In this manner, a user can create an instantaneous recommendation group. This may be particularly useful where a user has an immediate need for recommendations (e.g., in store purchase of a good/service) and where the user has no previously generated applicable group for recommendations. In these ad hoc groupings, the product/service is generally identified first and then the group is selected either from an existing grouping or from an unfiltered list of contacts associated with the user. The unfiltered list may first be filtered on any criteria prior to or during the selection of contacts to include in the ad hoc grouping.

In certain embodiments, the system may be configured to provide notifications to the contacts of a user being added to one or more groups via one or more social networks or other contact means from whence they were added. Notification may be through any number of means, including, but not limited to, via a social network, email, mobile application, text message, SMS message, instant message or any combination thereof. One of ordinary skill in the art would appreciate that there are numerous notification means, and embodiments of the present invention are contemplated for use with any notification means. The notification may inform the contact(s) that the user would like their comments, feedback, or advice on something they are looking to buy, whether now or in the future. In certain embodiments, the notification may be sent to multiple notification means associated with a contact (e.g., first to email, second to social network, third to SMS). In this manner, the system can attempt to track down contacts where immediate or prompt attention to a notification is desired.

In certain embodiments, the system may allow the contacts to first approve the addition of the contact to the specific group created by the user prior to entrance of that contact into the group. In this manner, the system may allow the contact to have control over whether they wish to participate or not in the recommendation process. In other embodiments, the prior approval may be optional or not required at all.

According to an embodiment of the present invention, the system may be configured to provide a feedback forum, where user's contacts who are members of a particular group can access and view the products/services to be reviewed. In most cases, the contacts who are members of the particular group selected to review a product/service will be allowed to leave feedback to the user with respect to a product/service. Feedback content may include, but is not limited to, rating (e.g., like/dislike, 0-10, 0-100) of the product/service, comments on the product/service, submission of additional images or other content related to the product/services, URLs or other links related to the product/services, or any combination thereof. The content of the feedback forum may be stored by the system for usage later by the user or anyone the user wishes to share the feedback forum with. In certain embodiments, the feedback forum may be shared with others via an number of means, such as a URL.

In certain embodiments, the feedback forum may allow contacts to comment, critique or otherwise provide interaction with input received from other contacts. In this manner, the feedback forum becomes a place where a conversation may occur regarding the products and/or services. Advantageously, since the user selects the contacts who will be involved in discussions in the feedback forum, the user can help create the interaction by way of selection of particular contacts that would be most relevant to a particular product/service.

According to an embodiment of the present invention, the feedback forum may also allow contacts to add product/service recommendations of their own to the feedback forum. In this manner, if a user has selected an inferior service provider or product, the user can quickly get recommendations for more relevant or better providers/products. The feedback forum may also allow for comment on the newly submitted products/services, allowing for the discussion to include those newly submitted products/services. In certain embodiments, the system may allow a user to spin off a newly submitted product/service recommendation into a new feedback forum as to not take away from the discussion of the originally submitted subject matter (i.e., the original product/service).

According to an embodiment of the present invention, the system may be configured to allow a user to allow, via a ‘Degrees of Separation’ number, to allow for the feedback of other people not immediately within a user's group of contacts. For instance, if a user allows for a Degrees of Separation of ‘2’, then the user's immediate circle (those entered via the user's social networks or email contacts) can solicit the advice of others within their circle. This is useful on a number of levels, including where there are only a limited number of contacts from the user currently available to make recommendations on an immediate need (e.g., in store purchase) and the user wishes to expand the contact basis for recommendations. Further, being able to obtain feedback from contacts that are part of the user's network of contacts broadens the circle of contacts, allowing user to obtain feedback only from contacts they personally know, or from contacts who are connected to someone the user knows, thereby greatly diminishing the possibility of false or paid-for endorsements.

According to an embodiment of the present invention, the system may be configured to allow narrowing of access by contacts associated by a degree of separation (e.g., not direct contacts) to those who have specific experience or meet other specific criteria. For instance, if a user is looking for recommendations on computers, the user may allow contacts associated by a degree of separation (e.g., 1, 2, 3, 4, 5) to provide recommendations or feedback if they have specific experience in computers or meet other specific criteria (e.g., have a degree in a related field, work in a related field, work for the company, work for a competitor). This allows users to focus their advice/recommendation/feedback requests to those with specific expertise in a field. Expertise may be identified by users (e.g., included during signup or when adding contacts), identified by data associated with the user or their contacts (e.g., information retrieved from third party social networks such as educational background and employment information), selected from a predefined list, entered via a keyword search, or any combination thereof. One of ordinary skill in the art would appreciate that there are numerous ways in which the areas of expertise of a contact or a contact associated by a degree of separation could be identified and utilized, and embodiments of the present invention are contemplated for use with any such methods of identifying such areas of expertise.

According to an embodiment of the present invention, the system allows a user to gather together contacts from various sources (e.g., email, IM, online social networks) into one location, gather together products/services found online/offline into one location, and then be able to group together products/services with groups of contacts such that the user can obtain the requested feedback by sending out the request once instead of multiple times through the various locations the contacts are available, such as via different email clients and different online social networks.

According to an embodiment of the present invention, the system may further allow a user to connect to the platform while shopping online and filter the feedback to only include those that the user wishes based on the ‘Degrees of Separation’. For instance, the user can filter the feedback provided on EBay, Amazon, Yelp, etc. so that the feedback displayed is only of those that are the user's contacts or, in certain embodiments, within the user's specified ‘n’ degrees of separation from the user.

According to an embodiment of the present invention, the system may be further configured to provide a user with access to feedback forums of their contacts on products/services previously discussed by the user's contacts. In this manner, if a user has identified a product/service they want to have recommendations on, but one of their contacts has already processed a feedback forum on that product/service, the user can read the feedback previously received and save time/energy on creating a new feedback forum.

According to an embodiment of the present invention, the system may be configured to provide relevant data with respect to a product/service to be subject to a recommendation. For instance, if a user wanted recommendations on a travel location, the system may be configured to provide data of related to that travel location, such as pertinent information (travel cost, temperature of the travel location, hours open, attractions) but allows for the user to act upon the advice by clicking/booking/buying through a single click, with the payment information (e.g., credit card, PayPal) stored within the system.

According to an embodiment of the present invention, the system may further be configured to identify the type/class of products/services identified by the user and offer alternative products/services based on this identification. For instance, if a user is looking for feedback on a particular insurance company offering, the system may be configured to identify the type of service (e.g., auto insurance) and offer alternative providers of that service. The provision of alternatives may further be enhanced by previous analysis through feedback forums on the system, whether these feedback forums were a part of discussions through the user's contacts or through entirely different contacts and groups. In certain embodiments, the type of recommendation may be made available to the user (e.g., this alternative reviewed by your contacts, this alternative reviewed by others outside your contacts).

According to an embodiment of the present invention, a list of feedback forums associated with a user may be presented to the user in a user dashboard. The user dashboard generally comprises graphical representations of one or more products/services the user requested recommendations on. The dashboard is intended to provide a quick and easy access point to individual feedback forums. The graphical representations may be aligned in a convenient manner to denote an ordering of feedback forums based on one or more criteria (e.g., date created, date of most recent new comment, grouped by product/service type, grouped by popularity). Preferably, the dashboard will show an initial number of available feedback forums (e.g., 4, 8, 10, 20), but through scrolling or other interaction with the dashboard, additional graphical representations can be loaded and displayed. In certain embodiments, the system can be configured to pre-load graphical representations of feedback forums not yet in view (i.e., pre-scrolling or other interaction) so they are ready to be displayed when the user does scroll or provide another interaction. An exemplary embodiment of the dashboard can be seen in FIG. 8C, where numerous products are shown, organized by date.

According to an embodiment of the present invention, indicia may be overlaid or used nearby the graphical representations of the dashboard to indicate that new recommendations have been taken on a feedback forum that the user has not yet reviewed. Indicia may include, but is not limited to, geometric shapes, visual signs or identifiers (e.g., exclamation points, check boxes, bubbles), textual indicia(e.g., numbers indicating how many new unviewed recommendations have been received), or any combination thereof. One of ordinary skill in the art would appreciate that there are numerous types of indicia that could be utilized with the dashboard, and embodiments of the present invention are contemplated for use with any appropriate indicia. An exemplary embodiment of indicia can be seen in FIG. 8C, where a circle containing the number “3” is used to denote that 3 new recommendations have been received on displayed products/services.

According to an embodiment of the present invention, the system can be further configured to provide user with connections to professional recommenders based on certain criteria, such as user's location, location of the product to be recommended (e.g., specific stores), or other information about the user (e.g., income, brand likes/affiliations, gender, age, profession) known to the system. For instance, in a preferred embodiment, the system may be configured to identify that the user is in a particular clothing store, based on the user's location as provided by their computing device (e.g., GPS, IP addressing) and provide the user with a list of stylist that are geographically local to the user or otherwise affiliated with the particular clothing store. The user can choose to select such a professional recommender from the list provided and use their professional recommendations in their overall selection process. Once connected, the professional recommender can provide recommendations on products/services identified by the user and enter into a back and forth exchange with the professional recommender, such as via messaging module provided by the system. An exemplary embodiment of this is shown in FIG. 8F, with a professional recommender requesting to be added to the user's contacts in order to provide recommendations on products/services stored by the user. In FIG. 8F, a brief description of the professional recommender is shown, along with the option for the recommender to accept or ignore the professional recommender.

According to an embodiment of the present invention, the system may further provide a landing page, with navigable options to reach the various components of the system, such as the gallery, dashboard, contacts and other components of the system. An exemplary embodiment of this is shown in FIG. 8E, where a landing page is shown with links for CAMERA, GALLERY, DASHBOARD, REQUESTS and LOGOUT. Indicia can be utilized next to the various navigable options to denote that there are pending actions to be taken in the related component identified by the navigable option. This can be seen in FIG. 8E, where the DASHBOARD option has a circle with a “3” in it, denoting that there are three items awaiting attention in the DASHBOARD portion of the system.

### Exemplary Embodiment

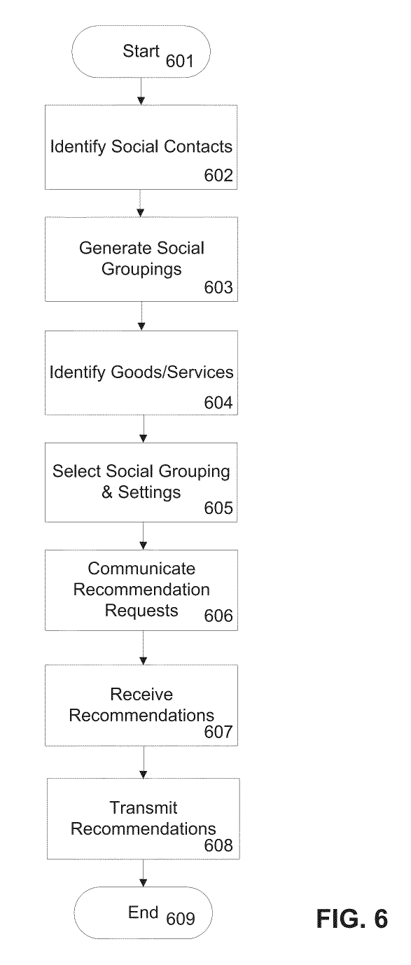

Turning now to FIG. 6, an exemplary method in accordance with an embodiment of the present invention is shown. In this method, the process starts at step 601 with a user interacting with the system. At step 602, the system is provided information related to the user and sets about identifying social contacts of the user. This can be achieved through access to one or more third party social networks, third party applications, direct provision by the user or any combination thereof. The system may allow for the sorting and filtering of individual contacts based on any number of criteria and assist the user with the selection of individuals (i.e. the system allows the user to select individuals by their Degrees of Separation from the user and the potential advisors' subject matter expertise). The system may display the potential advisors who are greater than 1 Degree of Separation from the user, but for privacy the system may mask the identity of the potential advisors that are not in the user's immediate social network and only display other information to aid the user in choosing the appropriate advisors, such as, but not limited to, geographic distance from the user or a given location, the subject matter expertise of the advisor, or any combination thereof

At step 603, the system has stored an identity associated with each of the user's contacts and provides the user the ability to generate one or more social groupings for providing recommendations on products/services. The system may allow for the sorting and filtering of both groups and individual contacts based on any number of criteria and assist the user with formation of such groups.

Once the group(s) is/are generated, the process continues with the provision of a product/service for recommendation as provided by the user (step 604). The provision of a product or service may be by way of an electronic medium received from the user. In certain cases, the user may provide more than one electronic medium (e.g., picture, txt, URL) for each product or service that they want recommendations on.

At step 605, the user will select the group(s) the user wants to receive recommendations from with respect to the identified product/service. Where more than one group is selected, the user may be allowed to decide if they want a single feedback form for the recommendations or for each individually selected group to have its own feedback forum for recommendations. This allows the user to potentially receive independent reviews based on different groupings, or, alternatively, receive the opinions of multiple groups in a single feedback forum. The user will also select the settings for recommendations at this step as well (e.g., Degrees of allowed separation for reviews). Alternatively, the user can also form a new group (i.e., ad hoc group) when the currently available groups do not meet the user's needs based on the identified product(s)/service(s)/item(s).

At step 606, the system communicates the request for recommendations to all selected contacts associated with the selected groups. The system identifies one or more appropriate notification means for each contact and transmits the request to each contact. In certain embodiments, the system may be configured to utilize multiple notification means for one or more of the selected contacts.

At step 607, the system received recommendations from the contacts, including responses to recommendations made by other contacts and the user. This process may continue for a specified period of time or left open, depending on the particular need and desire of the user.

At step 608, the system may optionally be configured to provide a final transmission of all recommendations and reviews to the user. This final transmission may also include a rating (e.g., 4/5) based on all recommendations/reviews received from the various contacts. At this point the process terminates at step 609.

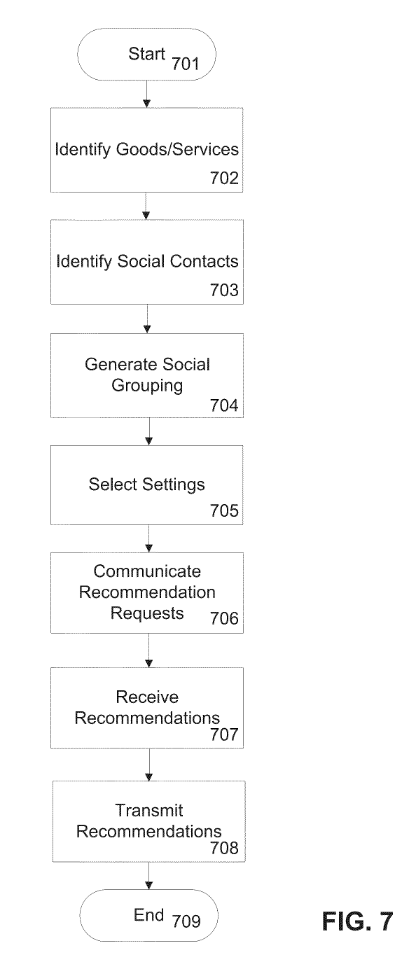

Turning now to FIG. 7, an exemplary method in accordance with an embodiment of the present invention is shown. In this method, the process starts at step 701 with a user interacting with the system. At step 702, the system is provided information from the user related to a product/service for recommendation. The provision of a product or service may be by way of an electronic medium received from the user. In certain cases, the user may provide more than one electronic medium (e.g., picture, txt, URL) for each product or service on which they want recommendations.

At step 703, the user will select social contacts of the user that the user wishes to receive recommendations from. This can be achieved through access to one or more third party social networks, third party applications, direct provision by the user or any combination thereof. The system may allow for the sorting and filtering of individual contacts based on any number of criteria and assist the user with the selection of individuals (i.e. the system allows the user to select individuals by their Degrees of Separation from the user and the potential advisors' subject matter expertise). The system may display the potential advisors who are greater than 1 Degree of Separation from the user, but for privacy the system may mask the identity of the potential advisors that are not in the user's immediate social network and only display other information to aid the user in choosing the appropriate advisors, such as, but not limited to, geographic distance from the user or a given location, the subject matter expertise of the advisor, or any combination thereof.

Once the selection of contacts has been completed, the system generates a social grouping to be used in the feedback process (Step 704). In certain embodiments, the system may allow the user to create more than one group through Steps 703 and 704. If multiple groups are created, the user may be allowed to decide if they want a single feedback form for the recommendations or for each individually selected group to have its own feedback forum for recommendations. This allows the user to potentially receive independent reviews based on different groupings, or, alternatively, receive the opinions of multiple groups in a single feedback forum.

At step 705, the user will select the settings for recommendations (e.g., Degrees of allowed separation for reviews). At step 706, the system communicates the request for recommendations to all selected contacts associated with the selected groups. The system identifies one or more appropriate notification means for each contact and transmits the request to each contact. In certain embodiments, the system may be configured to utilize multiple notification means for one or more of the selected contacts.

At step 707, the system received recommendations from the contacts, including responses to recommendations made by other contacts and the user. This process may continue for a specified period of time or left open, depending on the particular need and desire of the user.

At step 708, the system may optionally be configured to provide a final transmission of all recommendations and reviews to the user. This final transmission may also include a rating (e.g., 4/5) based on all recommendations/reviews received from the various contacts. At this point the process terminates at step 709.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive. CLAIMS

1. A web-based system for providing feedback from a user-selected group of contacts regarding a product, good, service, or item of interest selected by said user, the system comprising:
a processor,
a data store,
a communications means,
a social networking module, comprising computer-executable code stored in non-volatile memory and executed by said processor, and
a commerce module comprising computer-executable code stored in non-volatile memory and executed by said processor,
wherein said social networking module, said commerce module, said processor, said data store, and said communications means are operably connected and said processor is configured to process the computer-executable code of said modules configured to:
identify a user's contacts from said user's contact types comprising e-mail, phone, and social media, by accessing one or more third-party social networks through an Application Programming Interface (API) or accessing databases of third-party applications installed on a computing device of said user,
generate a list of contacts from said user's identified contacts,
obtain educational information, employment information, and information about a contact's past experience with a product, good, service, or item of interest by connecting to one or more third-party social networks through an API, said information corresponding to multiple contacts in said list of contacts,
determine an appropriate notification means for each of said contacts in said list of contacts, determined according to the contact type from which each of said contacts was identified,
provide notification, according to said determined appropriate notification means, to contacts to be included in one or more feedback groups,
receive permission to be added to said one or more feedback groups from said contacts to be included in said one or more feedback groups,
create said one or more feedback groups, each feedback group comprising one or more contacts in said list of contacts, and each feedback group corresponding to at least one of several user-provided criteria, said user-provided criteria comprising: said obtained educational information, employment information, and information about a contact's past experience with a product, good, service, or item of interest,
receive product information from the user regarding a product, good, service, or item of interest for which the user desires feedback, wherein said product information contains a link back to a source from which said product information was retrieved and is acquired via a computing device, transmitted from said computing device to said system for storage in said data store, and accessed by said commerce module,
add one or more of said feedback groups to a review group for said product, good, service, or item of interest,
create a web-accessible feedback forum for receiving recommendations from members of said review group through a network connection, said feedback forum presenting said product information to members of said review group,
communicate a request for recommendations to each contact in said review group, according to said determined appropriate notification means,
provide access to said product information stored in said data store, through said web-accessible feedback forum, to each contact in said review group,
receive, through said web-accessible feedback forum, one or more recommendations from at least one contact in said review group,
provide said one or more recommendations to said user through said web-accessible feedback forum,
identify one or more professional recommenders for said product, good, service, or item of interest based on said product information,
present said one or more professional recommenders to said user via notifications sent to said computing device of said user,
receive confirmation of said one or more professional recommenders via communications received from said computing device of said user.

2. The system of claim 1, further configured to receive one or more recommendations from an individual who is a contact of one or more of said identified contacts.

3. The system of claim 1, further configured to receive a degree of separation from said user, wherein said degree of separation defines an extent to which an individual who is not one of said identified contacts can provide recommendations.

4. The system of claim 1, further comprising a location module, comprising computer-executable code stored in non-volatile memory, said location module operably connected to and configured to work in conjunction with said social networking module, said commerce module, said processor, and said communications means.

5. The system of claim 4, wherein said location module is configured to provide location information to assist in (a) identifying one or more contacts to be added to said feedback groups and (b) identifying said one or more professional recommenders, in each case based on at least one of (1) geographic distance from the user or (2) geographic distance from the product, good, service or item of interest.

6. The system of claim 1, wherein said computing device is a mobile computing device associated with said user.

7. The system of claim 7, wherein said computing device uses one or more of the following integrated hardware features to acquire product, good, or service information: a microphone, a camera, a near field communications means, a wireless communications means, a Bluetooth communications means and a radio frequency identification means.

8. The system of claim 1, further configured to:
determine a product type for said product, good, service, or item of interest,
receive, from one or more review group members, one or more recommendations for one or more alternative products which are of the same determined product type, and
provide access to one or more additional feedback forums corresponding to one or more of the recommended alternative products of the same determined product type.

9. A web-based method for providing feedback from a user-selected group of contacts regarding a product, good, service, or item of interest selected by said user, the method comprising the steps of:
identifying a plurality of social contacts from said user's contact types comprising e-mail, phone, and social media, by accessing one or more third-party social networks through an Application Programming Interface (API) or accessing databases of third-party applications installed on a computing device of said user;
generating a list of contacts from said user's identified contacts;
obtaining educational information, employment information, and information about a contact's past experience with a product, good, service, or item of interest by connecting to one or more third-party social networks through an API, said information corresponding to multiple contacts in said list of contacts;
determining an appropriate notification means for each of said contacts in said list of contacts, determined according to the contact type from which each of said contacts was identified;
providing notification, according to said determined appropriate notification means, to contacts to be included in one or more feedback groups;
receiving permission to be added to said one or more feedback groups from said contacts to be included in said one or more feedback groups;
creating said one or more feedback groups, each feedback group comprising one or more contacts in said list of contacts, and each feedback group corresponding to at least one of several user-provided criteria, said user-provided criteria comprising: said obtained educational information, employment information, and information about a contact's past experience with a product, good, service, or item of interest;
receiving product information from the user regarding a product, good, service, or item of interest for which the user desires feedback, wherein said product information contains a link back to a source from which said product information was retrieved and is acquired via a computing device, transmitted from said computing device to said system for storage in said data store, and accessed by said commerce module;
adding one or more of said feedback groups to a review group for said product, good, service, or item of interest;
creating a web-accessible feedback forum for receiving recommendations from members of said review group through a network connection, said feedback forum presenting said product information to members of said review group;
communicating a request for recommendations to each contact in said review group, according to said determined appropriate notification means;
providing access to said product information stored in said data store, through said web-accessible feedback forum, to each contact in said review group;
receiving, through said web-accessible feedback forum, one or more recommendations from at least one contact in said review group;
providing said one or more recommendations to said user through said web-accessible feedback forum;
identifying one or more professional recommenders for said product, good, service, or item of interest based on said product information,
presenting said one or more professional recommenders to said user via notifications sent to said computing device of said user,
receiving confirmation of said one or more professional recommenders via communications received from said computing device of said user.

10. The method of claim 11, further comprising the step of receiving one or more recommendations from an individual who is not one of said plurality of social contacts, where said individual is a social contact of one or more of said plurality of social contacts.

11. The method of claim 11, further comprising the steps of:
receiving a degree of separation from said user wherein said degree of separation defines an extent to which an individual who is not one of said plurality of social contacts can provide recommendations,
receiving recommendations from social contacts which are not within said plurality of social contacts, but are within said degree of separation.

12. The method of claim 11, wherein said product information is provided via a mobile computing device associated with said user.

13. The method of claim 17, wherein integrated hardware of said mobile computing device is utilized to provide said information about said product, good, service, or item.

14. The method of claim 18, wherein said integrated hardware is selected from the group comprising, a microphone, a camera, a near field communications means, a wireless communications means, a Bluetooth communications means and a radio frequency identification means.

15. The method of claim 11, further comprising the steps of
determining a product type for said product, good, service, or item of interest,
receiving, from one or more review group members, one or more recommendations for one or more alternative products which are of the same determined product type, and
providing access to one or more additional feedback forums corresponding to one or more of the recommended alternative products of the same determined product type.

16. The method of claim 20, wherein contacts who are members of said review group can access and view said one or more additional feedback forums and provide feedback to the user which is posted for all review group members to view, comment, and discuss in said one or more additional feedback forums.

17. The method of claim 11 wherein said feedback groups in the review group are each provided an individual feedback forum wherein each individual feedback forum corresponds to the product, good, service, or item of interest identified by said user and a feedback group member can view said product information and provide independent feedback through the member's individual feedback forum.
